(19) United States
(12) Patent Application Publication
(10) Pub. No.: US 2023/0228904 A1
(43) Pub. Date: Jul. 20, 2023

(54) MUON TOMOGRAPHY METHOD AND APPARATUS

(71) Applicant: Atomic Energy of Canada Limited / Énergie Atomique du Canada Limitée, Chalk River (CA)

(72) Inventors: Oleg Kamaev, Chalk River (CA); Evan T. Rand, Chalk River (CA); Andrew Valente, Chalk River (CA); Amanjot Bhullar, Chalk River (CA)

(21) Appl. No.: 18/010,492

(22) PCT Filed: Jun. 16, 2021
(86) PCT No.: PCT/CA2021/050819

§ 371 Date: Dec. 15, 2022

Related U.S. Application Data
(60) Provisional application No. 63/039,540, filed on Jun. 16, 2020.

(51) Int. Cl. G01V 5/00

(52) U.S. Cl. CPC G01V 5/0025; G01V 5/005; G01V 5/0083

(57) ABSTRACT

A method of detecting a material with a high atomic number, including positioning a test object in a muon detection apparatus; gathering a set of test data; reconstructing a set of test muon tracks; identifying a set of outlier muon tracks having large scattering events; identifying an outlier spatial domain region; determining outlier region scattering density estimates; determining if the outlier region scattering density estimates are indicative of the presence of the material with the high atomic number; generating a detector notification, when the outlier region scattering density estimates are indicative of the presence of the material with the high atomic number; and providing the detector notification to a user. A system for detecting a material with a high atomic number may include a muon detection apparatus and a processing system communicatively coupled to the muon detection apparatus and including at least one processor operable to generate a detector notification.

### CROSS-REFERENCE TO RELATED APPLICATION

This application claims priority to U.S. Provisional Application No. 63/039,540 filed on Jun. 16, 2020, the entire contents of which are hereby incorporated herein by reference.

### FIELD

The specification relates generally to apparatuses and methods associated with detecting high atomic number materials, and more specifically to apparatus and methods using muon tomography to detect high atomic number materials.

### BACKGROUND

The following paragraphs are not an admission that anything discussed in them is prior art or part of the knowledge of persons skilled in the art.

Muons are often able to penetrate dense material. For example, naturally occurring cosmic-ray muons are often able to penetrate hundreds of meters of rock. In some cases, information about muons that have passed through an object can be used to obtain information about the object.

U.S. Pat. No. 9,035,236 to Anghel et al. (“Anghel”) purports to disclose a method of detecting high atomic number materials, such as Special Nuclear Materials, within a container based on muon tomography. The container is modeled as a plurality of volume elements. Information related to an initial trajectory and a final trajectory of each muon passing through the container is received. Additionally, a set of initial outer prong vectors and a set of final outer prong vectors are created. Then, a plurality of vector combinations are created from a selected initial vector and a selected final vector. A metric is determined and associated with each vector combination. A subset of the plurality of vector combinations is associated with each volume element and an estimated scattering density is determined and assigned to the volume element. Based on the estimated scattering density assigned to the volume elements, a three dimensional image of the container may be generated.

However, generating an image of an object often requires many hours of data to produce an image that can be interpreted by a user. Generating an image using a plurality of volume elements also often requires a tradeoff between image resolution and the sensitivity of each volume element.

### SUMMARY

The following summary is intended to introduce the reader to various aspects of the applicant's teaching, but not to define any invention.

According to some aspects, there is provided a method of detecting a material with a high atomic number, comprising positioning a test object that is to be examined in a muon detection apparatus; gathering a set of test data from the muon detection apparatus, the set of test data including a set of test trajectory pairs, each test trajectory pair of the set of test trajectory pairs including an incoming trajectory of a muon as the muon travels towards the test object and an outgoing trajectory of the muon as the muon travels away from the test object; reconstructing a set of test muon tracks from the set of trajectory pairs, each muon track of the set of test muon tracks including a scattering event and a scattering location; identifying a set of outlier muon tracks, the set of outlier muon tracks being muon tracks of the set of test muon tracks having scattering events larger than a predetermined minimum scattering size threshold; identifying an outlier spatial domain region having a spatial domain density of the scattering locations of the set of outlier muon tracks that is greater than a predetermined density threshold; determining outlier region scattering density estimates for test muon tracks having the scattering location in the outlier spatial domain region; determining, in an indicative step, if the outlier region scattering density estimates are indicative of the presence of the material with the high atomic number; generating a detector notification, when the outlier region scattering density estimates are indicative of the presence of the material with the high atomic number; and providing the detector notification to a user.

In some examples, the indicative step includes comparing the outlier spatial domain region to a corresponding reference region of a reference object by determining corresponding region scattering density estimates of the corresponding reference region; and determining a probability that the outlier region scattering density estimates and the corresponding region scattering density estimates originated from a common population.

In some examples, the detector notification includes a fail notice if the probability is below a predetermined difference threshold and the detector notification includes a pass notice if the probability is above the predetermined difference threshold.

In some examples, the method further comprises, prior to identifying the set of outlier muon tracks, combing the set of test muon tracks to remove any mis-reconstructed muon track having at least one of the scattering event being larger than a predetermined maximum scattering size threshold, and the scattering location being outside the object.

In some examples, identifying an outlier spatial domain region includes applying a clustering algorithm to identify a spatial cluster of the scattering locations of the set of outlier muon tracks, and defining a bounding box around the spatial cluster, the bounding box defining a set of spatial boundaries of the outlier spatial domain region.

In some examples, determining a probability that the outlier region scattering density estimates and the corresponding region scattering density estimates originated from a common population includes using a non-parametric statistical test to compare the outlier region scattering density estimates and the corresponding region scattering density estimates.

In some examples, the non-parametric statistical test includes the Anderson-Darling test.

In some examples, the predetermined minimum scattering size threshold includes a predetermined minimum angle threshold and a predetermined minimum distance threshold; each scattering event includes a scattering angle and a distance of closest approach; and identifying a set of outlier muon tracks includes identifying muon tracks having at least one of the scattering angle is larger than the predetermined minimum angle threshold and the distance of closest approach is larger than the predetermined minimum distance threshold.

In some examples, the muon detection apparatus includes at least two pairs of muon tracking detectors, and positioning a test object that is to be examined in a muon detection apparatus includes positioning the test object between the at least two pairs of muon tracking detectors.

In some examples, positioning a test object that is to be examined in a muon detection apparatus includes positioning the test object below a first pair of muon detectors of the at least two pairs of muon tracking detectors and above a second pair of muon detectors of the at least two pairs of muon tracking detectors.

According to some aspects, there is provided a system for detecting a material with a high atomic number, comprising a muon detection apparatus operable to detect an incoming trajectory of a muon and an outgoing trajectory of the muon, to generate a test trajectory pair; a processing system communicatively coupled to the muon detection apparatus to receive muon trajectory data comprising a set of test trajectory pairs from the muon detection apparatus, the processing system including at least one processor operable to reconstruct a set of test muon tracks from the set of test trajectory pairs, each muon track of the set of test muon tracks including a scattering event and a scattering location; identify a set of outlier muon tracks, the set of outlier muon tracks being muon tracks of the set of test muon tracks having scattering events larger than a predetermined minimum scattering size threshold; identify an outlier spatial domain region having a spatial domain density of the scattering locations of the set of outlier muon tracks that is greater than a predetermined density threshold; determine outlier region scattering density estimates for test muon tracks having the scattering location in the outlier spatial domain region; determine, in an indicative step, if the outlier region scattering density estimates are indicative of the presence of the material with the high atomic number; generate a detector notification, when the outlier region scattering density estimates are indicative of the presence of the material with the high atomic number; and provide the detector notification to a user.

In some examples, the indicative step includes comparing the outlier spatial domain region to a corresponding reference region of a reference object by determining corresponding region scattering density estimates of the corresponding reference region; and determining a probability that the outlier region scattering density estimates and the corresponding region scattering density estimates originated from a common population.

In some examples, the detector notification includes a fail notice if the probability is below a predetermined difference threshold and the detector notification includes a pass notice if the probability is above the predetermined difference threshold.

In some examples, the at least one processor is further operable to comb the set of test muon tracks to remove any mis-reconstructed muon tracks having at least one of the scattering event being larger than a predetermined maximum scattering size threshold, and the scattering location being outside the object.

In some examples, in identifying an outlier spatial domain region, the at least one processor is operable to apply a clustering algorithm to identify a spatial cluster of the scattering locations of the set of outlier muon tracks, and define a bounding box around the spatial cluster, the bounding box defining a set of spatial boundaries of the outlier spatial domain region.

In some examples, in determining a probability that the outlier region scattering density estimates and the corresponding region scattering density estimates originated from a common population, the at least one processor is operable to apply a non-parametric statistical test to compare the outlier region scattering density estimates and the corresponding region scattering density estimates.

In some examples, the non-parametric statistical test includes the Anderson-Darling test.

In some examples, the predetermined minimum scattering size threshold includes a predetermined minimum angle threshold and a predetermined minimum distance threshold; each scattering event includes a scattering angle and a distance of closest approach; and in identifying a set of outlier muon tracks, the at least one processor is operable to identify muon tracks having at least one of the scattering angle is larger than the predetermined minimum angle threshold and the distance of closest approach is larger than the predetermined minimum distance threshold.

In some examples, the muon detection system includes at least two pairs of muon tracking detectors and the muon detection apparatus is operable to detect the incoming trajectory and the outgoing trajectory when the object is between the at least two pairs of muon tracking detectors.

In some examples, the muon detection apparatus includes a first pair of muon detectors and a second pair of muon detectors below the first pair of muon detectors, and the muon detection apparatus is operable to detect the incoming trajectory and the outgoing trajectory when the object is below the first pair of muon detectors and above the second pair of muon detectors.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a schematic diagram of a muon detection apparatus;

FIG. 2 is a schematic diagram of a muon detection system;

FIG. 3 is a schematic diagram of the output of a processing system of the muon detection system of FIG. 2;

FIG. 4 is a graph of the angle and distance of closest approach of a set of test scattering locations of a first set of experimental data from a first experimental setup;

FIG. 5 is a graph of spatial positions of the set of test scattering locations of FIG. 4;

FIG. 6 is a graph of spatial positions of a set of outlier scattering locations of the set of test scattering locations of FIG. 4;

FIG. 7 is a graph of scattering density estimate distributions of the set of test scattering locations of FIG. 4 compared to scattering density estimate distributions of a set of reference scattering locations;

FIG. 8 is a graph of a set of receiver operating characteristic curves of a plurality of sets of data from the first experimental setup of FIG. 4;

FIG. 9 is a schematic diagram of a second experimental setup;

FIG. 10 is a graph of a set of receiver operating characteristic curves of a plurality of sets of data from the second experimental setup of FIG. 9; and

FIG. 11 is a flowchart of a method of detecting a material with a high atomic number.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses or process described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim, or dedicate to the public any such invention by its disclosure in this document.

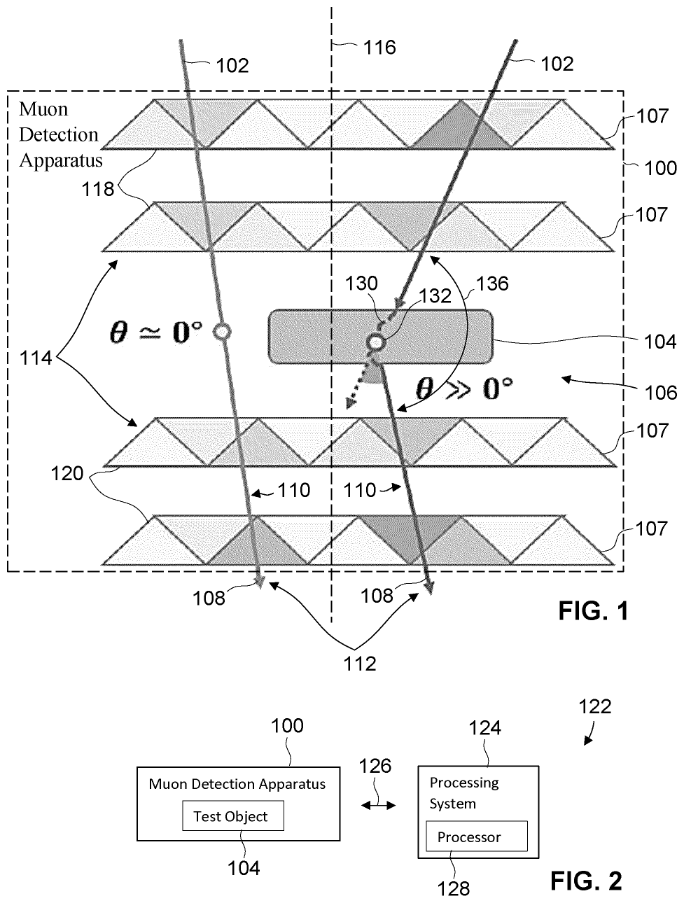

Referring to FIG. 1, a muon detection apparatus 100 is illustrated. The muon detection apparatus 100 is operable to detect a material with a high atomic number. In some examples, the material with the high atomic number includes fissile material, such as uranium and plutonium. In some examples, the material with the high atomic number includes any materials with an atomic number greater than 80.

The muon detection apparatus 100 is operable to detect an incoming trajectory 102 of a muon and an outgoing trajectory 108 of a muon. For example, the muon detection apparatus 100 may be operable to detect the incoming trajectory 102 of a muon on its way towards an object 104. In some examples, the muon detection apparatus 100 is operable to detect the incoming trajectory 102 of a muon on its way to a receiving space or scanning space 106; a volume in which the object 104 may be received. The muon detection apparatus 100 may also be operable to detect the outgoing trajectory 108 of a muon on its way from the object 104 and/or the receiving space 106.

The incoming trajectory 102 and the outgoing trajectory 108 form a trajectory pair 110. The trajectory pair 110 may provide information about the object 104. For example, the trajectory pair 110 may indicate that the muon changed direction on its way through the object 104. The muon detection apparatus 100 is operable to detect a set of test trajectory pairs 112 including a plurality of trajectory pairs associated with the object 104. Muon trajectory data generated by the muon detection apparatus 100 may include the set of test trajectory pairs 112.

Detecting the incoming trajectory 102 and the outgoing trajectory 108 may involve a plurality of tracking detectors. The muon detection apparatus 100 includes at least two pairs of muon tracking detectors 114. The muon detection apparatus 100 is operable to detect the incoming trajectory 102 and the outgoing trajectory 108 when the object 104 is between the at least two pairs of muon tracking detectors 114. For example, the muon detection apparatus may have four or more muon tracking detectors spaced about a receiving volume 106, and may be operable to detect incoming and outgoing trajectories of muons after the object 104 is placed into the receiving volume 106.

In some examples, each muon tracking detector 107 includes two layers, each including a set of parallel scintillator bars. The two layers may be arranged orthogonal to one another. An (x,y,z) coordinate of a muon impact can be determined using the known height of the detector 107 as the z coordinate, the location of the impacted scintillator bar of one layer of the detector 107 as the x coordinate, and the location of the impacted scintillator bar of the other layer as the y coordinate. In some examples, each scintillator bar is a polystyrene scintillator bar infused with 2,5,-diphenyloxazole and 1,4-bis-(2-(5-phenyloxazolyl)) fluors, 1% and 0.03% by weight, respectively. In some examples, each scintillator bar has a triangular cross-section with an extrusion hole in the center for scintillation light readout to photo-multiplier tubes via Yl1 Kuraray wavelength-shifting optical fibers.

In the illustrated example, the muon detection apparatus 100 includes a vertical axis 116, a first pair of two muon detectors 118, and a second pair of muon detectors 120 below the first muon detector 118. The muon detection apparatus 100 is operable to detect the incoming trajectory 102 and the outgoing trajectory 108 when the object 104 is positioned below the first pair of muon detectors 118 and above the second pair of muon detectors 120. Positioning the first pair of muon detectors and the second pair of muon detectors along a vertical axis may facilitate use with naturally occurring cosmic-ray muons. However, in some examples the muon detection apparatus 100 may work with artificially generated muons. In the illustrated examples, relative to an entry plane above the object 104, the pairs of muon detectors 118, 120 are configured to detect the location where the trajectory 102 intersects the entry plane and the angle relative to that plane, and correspondingly for the trajectory 108 and relative to an exit plane below the object 104, the pairs of muon detectors 118, 120 are configured to detect the location where the trajectory 108 intersects the exit plane and the angle relative to the exit plane.

Referring to FIG. 2, in some examples the muon detection apparatus 100 is part of a muon detection system 122 for detecting a material with a high atomic number. The illustrated example muon detection system 122 includes the muon detection apparatus 100, and a processing system 124 communicatively coupled to the muon detection apparatus 100. The processing system 124 is communicatively coupled to the muon detection apparatus 100 to receive muon trajectory data from the muon detection apparatus 100.

In the illustrated example, the processing system 124 is communicatively coupled to the muon detection apparatus by one or more wired connections 126. In other examples, the processing system 124, the processing system 124 is communicatively coupled to the muon detection apparatus 100 through a wireless network.

The processing system 124 includes at least one processor 128. The at least one processor includes at least one local processor and/or at least one remote processor. For example, the muon detection apparatus 100 may be communicatively couple to a remote server to process the muon trajectory data. In another example, the at least one processor 128 may be a processor physically integrated with the muon detection apparatus 100 or adjacent the muon detection apparatus 100 and joined by a wired connection.

The at least one processor 128 is operable to process muon trajectory data from the muon detection apparatus 100 to generate a detector notification.

Referring again to FIG. 1, a muon may undergo multiple scattering along a muon path 130 within the object 104. The at least one processor 128 is operable to reconstruct a muon track for each trajectory pair 110. In some examples, the at least one processor is operable to reconstruct a set of test muon tracks from a set of test trajectory pairs. Each muon track includes a scattering event and a scattering location 132. The scattering event includes a distance of closest approach and a scattering angle 136.

In some examples, a Point of Closest Approach (PoCA) reconstruction technique is used to reconstruct the muon tracks. The PoCA technique relies on the simplified assumption that the muon scattering occurs in a single point. The trajectory point along each incoming and outgoing trajectory that is closest to the other of the incoming and outgoing trajectories is located, and the midpoint between these trajectory points is designated the scattering location. The distance of closest approach is taken as the distance between the trajectory points. For example, if the incoming and outgoing trajectories cross, the scattering point is the point at which they cross and the distance of closest approach is zero. In another example, if the incoming and outgoing trajectories pass, at their closest point, 2 cm from one another, the scattering location is the point midway between at this closest point and the distance of closest approach is 2 cm. This method is computationally simple and provides a useful first-order approximation to the problem.

In other examples, the muon tracks are reconstructed with other methods, such as an autocorrelation analysis, clustering algorithms, and maximum likelihood estimation as described in “Riggi, S. (2013). Muon tomography imaging algorithms for nuclear threat detection inside large volume containers with the Muon Portal detector. Nuclear Instruments Adn Methods in Physics Research, 728, 59-68”.

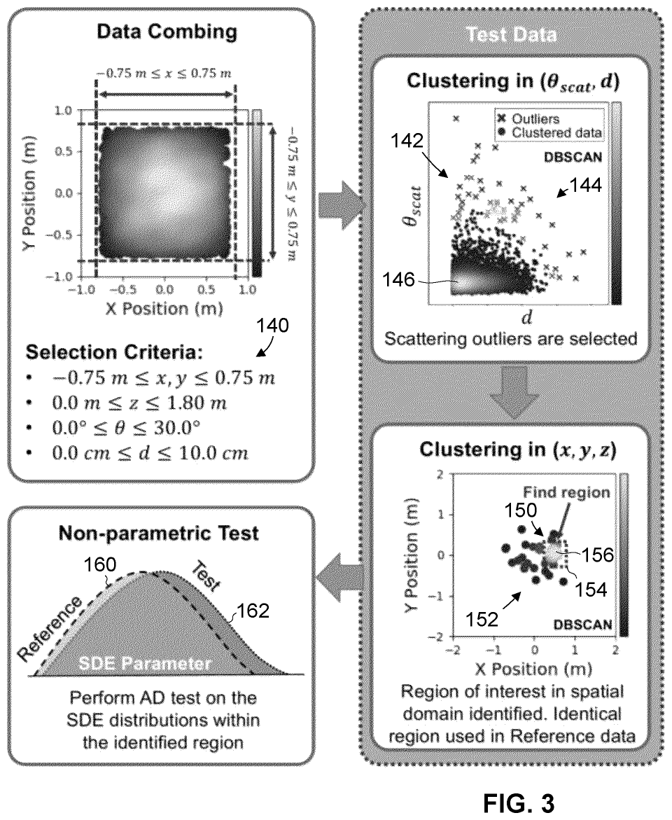

Referring now to FIG. 3, in some examples the at least one processor 128 is operable to comb the set of test muon tracks to remove any mis-reconstructed muon tracks. A mis-reconstructed muon track may be a muon track having a parameter that indicates that the muon track was not properly reconstructed. In some examples, a mis-reconstructed muon track has a parameter, such as a scattering angle, indicating that the trajectory pair are not from the same muon.

In some examples, a mis-reconstructed muon track is a muon track having a scattering event that is larger than a predetermined maximum scattering size threshold, such as a scattering angle greater than a predetermined maximum angle threshold or a distance of closest approach greater than a predetermined maximum distance threshold. In some examples, a mis-reconstructed muon track is a muon track having a scattering location outside of the object and/or outside of a predetermined receiving volume, such as receiving volume 106.

In the illustrated example of FIG. 3, any reconstructed muon track is considered mis-reconstructed if it includes a value that falls outside of a set of selection criteria 140. In one example, the selection criteria 140 includes a scattering location with an x-coordinate outside of −0.75 meters to +0.75 meters, a y-coordinate outside of −0.75 meters to +0.75 meters, or a z-coordinate outside of 0 meters to +1.80 meters, or a scattering angle, Γ_{scat}, outside of 0° to 30° or a distance of closest approach, d, outside of 0 cm to 10 cm.

In some examples, reconstructed muon tracks that have large scattering angles and/or large distances of closest approach are more likely to be associated with a material having a high atomic number when not mis-reconstructed. Still referring to FIG. 3, the at least one processor 128 is operable to identify a set of outlier muon tracks 142. In some examples, the set of outlier muon tracks 142 are muon tracks of the full set of muon tracks 144 that have a scattering event that is larger than a predetermined minimum scattering size threshold. Where the full set of muon tracks 144 and/or the outlier muon tracks 142 are combed, these outlier muon tracks 142 are those that have a scattering event that is both larger than a predetermined minimum and smaller than a predetermined maximum.

In some examples, the scattering event is larger than a predetermined minimum scattering size threshold when a scattering angle is larger than a predetermined minimum angle threshold and/or a distance of closest approach is larger than a predetermined minimum distance threshold. In the illustrated example, the set of outlier muon tracks 142 are muon tracks determined to be outside of the scattering cluster 146 of low scattering muon tracks by a clustering algorithm, such as the Density Based Spatial Clustering of Applications with Noise (DBSCAN) algorithm of the scikit-learn library.

When a set of outlier muon tracks 142 has been identified, the at least one processor 128 is operable to identify an outlier spatial domain region 150. The outlier spatial domain region 150 has a spatial domain density of the outlier scattering locations 152 of the set of outlier muon tracks 142 that is greater than a predetermined density threshold. In the illustrated example, the outlier spatial domain region 150 is determined by a clustering algorithm, such as DBSCAN.

In some examples, the at least one processor 128 is operable to define a bounding box 154 around the spatial cluster 156. The bounding box 154 defines a set of spatial boundaries of the outlier spatial domain region. In some examples, the bounding box 154 is defined by the minimum and maximum values of each coordinate of the scattering locations of the spatial cluster 156.

Defining the bounding box based on a spatial cluster avoids introducing an arbitrary setting. For example, rather than subdividing the entire scanning volume into an even distribution of sub volumes, such as for comparison to sub volumes of a reference object, a sub volume is chosen based on the size of a cluster.

The at least one processor 128 is operable to determine if the scattering locations of the outlier muon tracks are indicative of the presence of the material with the high atomic number. For example, the presence of a spatial cluster of scattering locations of outlier muon tracks may indicate the presence of a material with a high atomic number.

Referring again to FIG. 3, in some examples the at least one processor 128 is operable to determine scattering density estimates for muon tracks. In some examples, the scattering density estimates for a test muon track incorporates a scattering density estimate parameter. The scattering density estimate parameter is defined as:

$$λ = \frac{{θ}_{scat}^{3} {p}^{2}}{d}$$

Wherein θ_{scat} is the three-dimensional scattering angle of the muon track, p is the momentum of the muon, and d is the distance of closest approach of the muon track.

In some examples, the at least one processor 128 is operable to determine scattering density estimates for outlier region muon tracks; all muon tracks that have the scattering location of the muon track in the outlier spatial domain region 150. In some examples the at least one processor 128 is operable to determine, in an indicative step, if the outlier region scattering density estimates are indicative of the presence of the material with the high atomic number.

The muon detection system 122 may be used to verify that containers having an expected configuration and content do in fact have the expected content. For example, a reference object may be compared to the test object. The reference object may be, for example, a spent fuel storage cask that has been examined and can be compared to test objects such as other spent fuel storage casks. The reference object can be used to verify that the test objects have not be altered to contain additional high atomic number material, without requiring that the test objects be opened and examined. The reference object may be a shipping container to be compared to shipping containers coming out of a nuclear facility.

In the illustrated example, the indicative step includes comparing the outlier spatial domain region to a correspondingly positioned reference region of a reference object. For example, information about a corresponding reference region of a reference object may be obtained by placing the reference object in the muon detection apparatus 100, and information may be gathered from the muon detection apparatus 100. In another example, the at least one processor 128 may be communicatively coupled to one or more data storage devices. Information about the reference object may be stored on the one or more data storage devices, and retrieved by the at least one processor 128 for comparison.

In some examples, the at least one processor 128 is operable to determine and/or retrieve corresponding region scattering density estimates of a region of the reference object corresponding to the outlier spatial domain region. In some examples, the at least one processor 128 is operable to determine a probability that the outlier region scattering density estimates and the corresponding region scattering density estimates originated from a common population.

FIG. 3 depicts an example comparison; a reference distribution of scattering density estimates 160 is compared to a test distribution of scattering density estimates 162. The graphical illustration indicates that the two distributions are not aligned, and may come from different populations.

In some examples, the at least one processor 128 may apply a non-parametric statistical test to compare the outlier region scattering density estimates and the corresponding region scattering density estimates. In some examples, the at least one processor 128 is operable to apply an Anderson-Darling test to compare the outlier region scattering density estimates and the corresponding region scattering density estimates, such as to generate a probability value.

The at least one processor 128 is operable to generate a detector notification, when the outlier region scattering density estimates are indicative of the presence of the material with the high atomic number. In some examples, the detector notification is based on the probability value. In some examples, the detector notification includes a single decision value for the absence and/or presence of the material with the high atomic number, such as a heavy nuclear warhead core. For example, detector notification may include a single decision value to avoid the need for a detailed visual reconstruction and/or human interpretation.

In some examples, the detector notification is generated regardless of whether the material with the high atomic number is detected, and includes a pass notice if the material is not detected. In some examples, if the probability is below a predetermined difference threshold the detector notification includes a fail notice and if the probability is above the predetermined difference threshold the detector notification includes a pass notice.

In some examples, the detector notification includes a determination of whether a localized region of the scattering density estimate from a test object and the corresponding region from a reference object originate from the same population. For example, the Anderson-Darling test may generate a p-value statistic that is high if the test and reference objects scattering density estimates have a high likelihood of originating from the same population, and low if the test and reference object scattering density estimates have a low likelihood of originating from the same population.

The probability may be compared to a threshold level in some examples to determine if it is indicative of the presence of the material with the high atomic number. A threshold level may be set based on operational constraints, such as the acceptable false positive rate of the detection.

The use of a different type of non-parametric test to detect high atomic number materials—the Kolmogorov-Smirnov test—is described in U.S. Pat. No. 8,143,575 B2 “Detection of High Z Materials Using Reference Database”. Specifically, U.S. Pat. No. 8,143,575 describes evaluating the correlation between the actual and reference distributions via the Kolmogorov-Smirnov test.

In experiments such as those detailed below, the results of the Anderson-Darling test were compared to the results of the Kolmogorov-Smirnov test and found to consistently outperform the Kolmogorov-Smirnov test for various experimental and simulated setups. In particular, the presence of high atomic number material produces much wider tails in the scattering density estimate distributions. Additionally, the Anderson-Darling test was found to be much more sensitive to the shape and tails of the distributions than other non-parametric tests including the Kolmogorov-Smirnov test.

In some examples, the at least one processor 128 is operable to provide the detector notification to a user. For example, the at least one processor 128 may be communicatively coupled to a speaker to provide an audible alarm, to a screen to provide an image notice, or to a haptic feedback system to provide a haptic notice. The user may then further investigate in some example, such as by manually investigating or conducting further tests.

The at least one processor 128 may be operable to provide the detector notification to a user by turning on a light, such as a red light. In some examples, the at least one processor is operable to provide the detector notification to a user by turning on a first light, such as a green light, if the detector notification includes a pass notice, and turning on a second light, such as a red light, if the detector notification includes a fail notice. For example, when the calculated p-value returned by the algorithm is smaller than the set threshold, an alarm, such as a red light, may go on to inform a user of suspicious content.

Providing only a pass and/or a fail notice to a user may prevent the user from receiving information they are not meant to have, such as details about the configuration of the scanned object. In some examples, the muon detection apparatus 100 and the processing system 124 are operated for a limited time to avoid generating enough data for a high-quality image. For example, an arms treaty may require that a missile has no more than the allowed number of nuclear warheads inside a weapon delivery system. The limited natural rate of cosmic-ray muons makes it physically impossible to produce detailed images in short acquisition times, thus keeping the smaller technological details hidden while still allowing verification that a particular missile has no more than the allowed number of nuclear warheads.

Providing only a pass and/or a fail notice to a user may avoid the need for the user to interpret an output, such as avoiding the need for the user to decide if an image indicates the presence of the material with the high atomic number.

In some examples, the muon detection apparatus 100 and the processing system 124 are operated for a limited time for throughput reasons. For example, when scanning objects to determine if they contain a material with a high atomic number hidden within, the processing system 124 may be operable to generate an answer quickly, such as within several minutes or less than half an hour.

In some examples, the muon detection apparatus 100 generates a sufficient number of test trajectory pairs within several minutes for the at least one processor 128 to accurately generate the detector notification. In some examples, the muon detection apparatus 100 generates a sufficient number of test trajectory pairs for the detector notification within 5 minutes or within 10 minutes or within half an hour. By comparison, in some cases muon imaging techniques require many hours of muon data to reconstruct high-quality images.

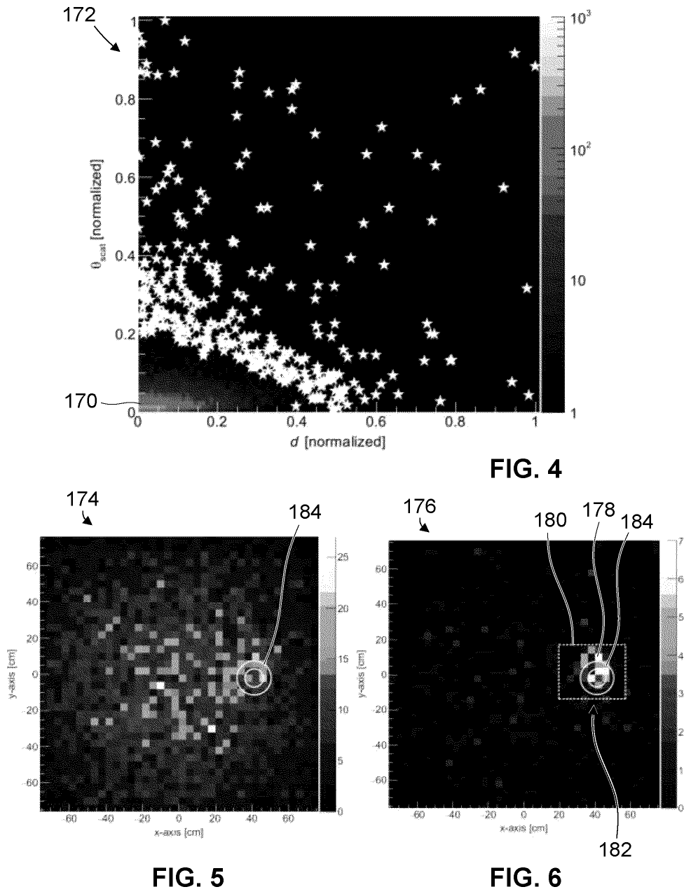

Referring to FIG. 4, in an experimental example a first test object was created by placing a cylindrical lead flask on a concrete cinder block off-center within a scanning volume of a muon detection apparatus, similar to the receiving volume 106 of the muon detection apparatus 100. The lead flask was placed approximately half a meter in the +x direction The lead flask had an outer diameter of approximately 19 cm and a height of approximately 30 cm. A cavity inside the lead flask was approximately 10 cm in diameter and 15 cm in height.

To gather a first set of data, the muon detection apparatus was operated to gather ten thousand trajectory pairs. The ten thousand trajectory pairs were provided to a processing system, which reconstructed ten thousand muon tracks from the ten thousand trajectory pairs. FIG. 4 depicts the scattering events of the ten thousand reconstructed muon tracks. A scattering cluster 170 near the origins of the angle and distance axes is identified by the DBSCAN algorithm, and represents low-scattering events. The stars 172 represent unclustered, or outlier, muon tracks.

Referring to FIGS. 5 and 6, the scattering locations of the muon tracks of FIG. 4 are mapped on a scattering map 174 in FIG. 5. Scattering locations of only the outlier muon tracks are mapped on an outlier map 176 in FIG. 6. A spatial cluster 178 was identified by running the DBSCAN algorithm again on the x and y positions of the scattering locations. A bounding box 180 is found by taking the minimum and maximum positional values of the clustered data. The bounding box 180 defined an outlier spatial domain region 182 for the experimental example. The actual location of the lead flask is indicated by an outline 184.

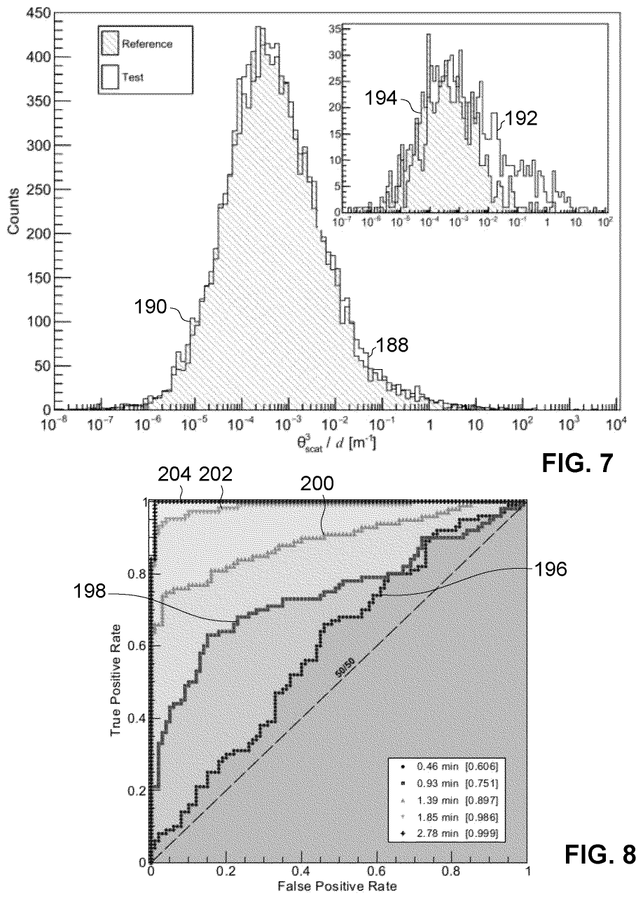

Referring now to FIG. 7, the outlier spatial domain region 182 was compared to a corresponding region of a reference object. The outlier region scattering density estimates of the muon tracks having a scattering location in the outlier spatial domain region were calculated. These outlier region scattering density estimates were compared to the corresponding region scattering density estimates of the muon tracks having scattering locations in the corresponding region.

Illustrated in FIG. 7 is a full test distribution 188 of test object scattering density estimates for the full set of test object muon tracks. The full test distribution 188 is compared to the full reference distribution 190 of reference object scattering density estimates for the full set of reference object muon tracks. Also illustrated is the outlier region distribution 192 of the scattering density estimates of outlier region muon tracks and the corresponding distribution 194 of the scattering density estimates for the corresponding region of the reference object. As may be seen, the difference between the test and reference objects is substantially clearer when comparing only the outlier region and the corresponding region. The test case had a much wider tail, indicating the presence of material with a high atomic number.

In one example, the probability value (p-value) generated by the Anderson-Darling test for the outlier region distribution 192 and the corresponding distribution 194 was 1.071×10⁻²⁸ while the p-value generated for the full test distribution 188 and the full reference distribution 190 was 7.413×10⁻³. A p-value of 7.413×10⁻³ was arguably not significant for the illustrated example, but a p-value of 1.071×10⁻²⁸ indicated that the two distributions were quite different.

Referring to FIG. 8, illustrated is a set of receiver operating characteristic curves of the test object discussed in FIGS. 4 to 7 for various detection times. A receiver operating characteristic curve shows the performance of one detection time at all classification thresholds, and can be used to evaluate the strength of a model by plotting the true positive rate on the y-axis versus the false positive rate on the x-axis. A greater area under the curve indicates a better classifier, as this means a higher true positive rate and a lower false positive rate.

The receiver operating characteristic curves of FIG. 8 were obtained by gathering data from the experimental set up over a period of hours. For each curve, the total data set was broken into portions of the desired detection time length, and the p-value for each data portion was obtained. A distribution for that detection time length was determined for each classification threshold, and the results plotted as a curve.

In the illustrated example, the first curve 196 corresponds to a detection time of 0.46 minutes, with a resulting area under the curve of 0.606. The second curve 198 corresponds to an exposure time of 0.93 minutes, with a resulting area under the curve of 0.751. The third curve 200 corresponds to an exposure time of 1.39 minutes, with a resulting area under the curve of 0.897. The fourth curve 202 corresponds to an exposure time of 1.85 minutes, with a resulting area under the curve of 0.986. The fifth curve 204 corresponds to an exposure time of 2.78 minutes, with a resulting area under the curve of 0.999.

Accordingly, in some examples, excellent results are produced with exposure times under two minutes.

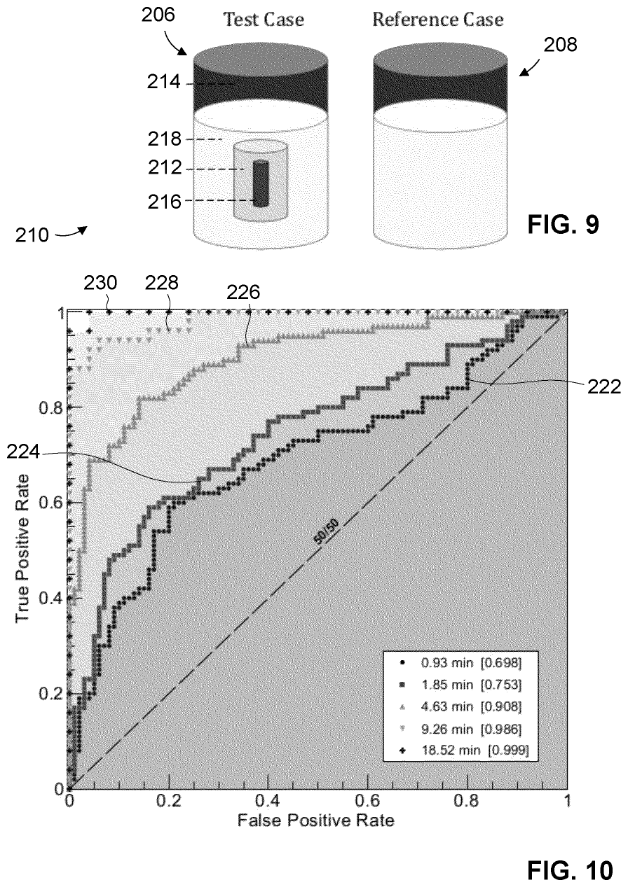

Referring to FIG. 9, illustrated is an example of a test object 206 and a reference object 208 of a second experimental setup 210. In the experimental setup 210, a cylindrical lead flask 212 was placed in a steel drum 214 of approximately 210 liters, and used to shield 2.13 kg of depleted uranium 216. Depleted Uranium (DU) has a similar composition and density as highly enriched uranium, and can be expected to produce muon scattering results similar to highly enriched uranium.

Equal amounts of sand 218 surrounded the lead flask 212, with approximately 20 cm of sand below, above, and to each side of the lead flask 212. The reference object 208 was similar, but with extra sand taking the place of the lead flask 212 and depleted uranium 216.

Referring now to FIG. 10, illustrated is an example of a set of receiver operating characteristic curves for the test object 206 and reference object 208 for various detection times. As discussed above, a greater area under the curve indicates a better classifier, as this means a higher true positive rate and a lower false positive rate.

In the example illustrated in FIG. 10, the first curve 222 corresponds to an exposure time of 0.93 minutes, with a resulting area under the curve of 0.698. The second curve 224 corresponds to an exposure time of 1.85 minutes, with a resulting area under the curve of 0.753. The third curve 226 corresponds to an exposure time of 4.63 minutes, with a resulting area under the curve of 0.908. The fourth curve 228 corresponds to an exposure time of 9.26 minutes, with a resulting area under the curve of 0.986. The fifth curve 230 corresponds to an exposure time of 18.52 minutes, with a resulting area under the curve of 0.999.

Accordingly, in some examples, excellent results are produced with exposure times under 10 minutes, and at an exposure time of 18.52 minutes the area under the curve begins to approach perfect detection of the material.

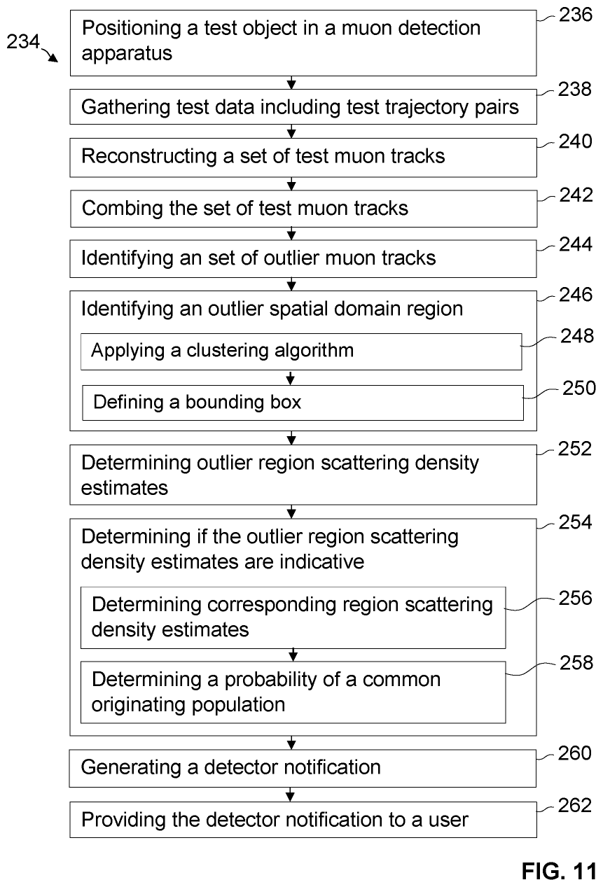

Referring now to FIG. 11, illustrated is a method 234 of detecting a material with a high atomic number. In some examples, the method 234 is a passive, non-destructive method using muon tomography.

The method 234 includes positioning 236 a test object that is to be examined in a muon detection apparatus. For example, the method 234 may include placing the object 104 in the muon detection apparatus 100 of FIG. 1, such as within the receiving volume 106 of the muon detection apparatus 100.

In some examples, the muon detection apparatus 100 includes at least two pairs of muon tracking detectors, and positioning a test object that is to be examined in a muon detection apparatus includes positioning the test object between the at least two pairs muon tracking detectors. In some examples, positioning a test object that is to be examined in a muon detection apparatus includes positioning the test object below a first pair of muon detectors of the at least two pairs of muon tracking detectors and above a second pair of muon detectors of the at least two muon tracking detectors.

The method 234 also includes gathering 238 a set of test data from the muon detection apparatus, the set of test data including a set of test trajectory pairs. For example, the muon detection apparatus 100 may be used to gather the set of test trajectory pairs 112 from the object 104.

The set of test trajectory pairs 112 of FIG. 1 includes only two trajectory pairs, however in some examples a set of test trajectory pairs may include hundreds or thousands or more, collected over several seconds or minutes or more. For example, the muon detection apparatus 100 may detect many thousands of trajectory pairs passing through a plane measuring 150 cm by 150 cm over a period of a few minutes.

The method 234 includes reconstructing 240 a set of test muon tracks from the set of trajectory pairs. Each muon track of the set of test muon tracks includes a scattering event and a scattering location. In some examples, the scattering event includes a scattering angle and a distance of closest approach.

In some examples, the method 234 includes combing 242 the set of test muon tracks to remove one or more mis-reconstructed muon tracks. Combing the set of test muon tracks is done prior to identifying 244 the set of outlier muon tracks. Mis-reconstructed muon tracks may be misinterpreted as outlier muon tracks in some cases if not removed. Any muon tracks having a scattering event larger than a predetermined scattering size threshold or a scattering location outside of the object and/or a scanning volume are identified as mis-reconstructed and are removed.

The method 234 also includes identifying 244 a set of outlier muon tracks. The set of outlier muon tracks are muon tracks having scattering events larger than a predetermined minimum scattering size threshold. Where the method 234 includes combing 242, the set of outlier muon tracks are muon tracks having scattering events larger than the predetermined minimum scattering size threshold and smaller than the predetermined maximum scattering size threshold.

In some examples, the predetermined minimum scattering size threshold includes a predetermined minimum angle threshold and/or a predetermined minimum distance threshold. Identifying a set of outlier muon tracks includes identifying muon tracks having at least one of a scattering angle larger than the predetermined minimum angle threshold and a distance of closest approach larger than the predetermined minimum distance threshold.

Once a set of outlier muon tracks are identified, the method 234 includes identifying 246 an outlier spatial domain region having a spatial domain density of the scattering locations of the set of outlier muon tracks that is greater than a predetermined density threshold.

In some examples, the method includes applying 248 a clustering algorithm to identify a spatial cluster of the scattering locations of the set of outlier muon tracks and defining 250 a bounding box around the spatial cluster, the bounding box defining a set of spatial boundaries of the outlier spatial domain region.

In some examples, the method 234 includes determining 252 outlier region scattering density estimates for test muon tracks of the test object that have a scattering location in the outlier spatial domain region. The scattering density estimates for the outlier region muon tracks may be used to determine if the material with the high atomic number is present. The method 234 includes determining, in an indicative step 254, if the outlier region scattering density estimates are indicative of the presence of the material with the high atomic number.

In some examples, the indicative step 254 includes comparing the outlier spatial domain region to a corresponding reference region of a reference object. The comparison includes determining 256 corresponding region scattering density estimates of the corresponding reference region and determining 258 a probability that the outlier region scattering density estimates and the corresponding region scattering density estimates originated from a common population.

In some examples, determining 258 a probability that the outlier region scattering density estimates and the corresponding region scattering density estimates originated from a common population includes using a non-parametric statistical test to compare the outlier region scattering density estimates and the corresponding region scattering density estimates. In some examples, the non-parametric statistical test includes the Anderson-Darling test.

The method 234 also includes generating 260 a detector notification, when the outlier region scattering density estimates are indicative of the presence of the material with the high atomic number. In some examples, the detector notification includes a fail notice if the probability is below a predetermined difference threshold and the detector notification includes a pass notice if the probability is above the predetermined difference threshold.

The method 234 also includes providing 262 the detector notification to a user. For example, an audible alert may be sounded, an image provided, or a haptic feedback event generated.

In some examples, the detector notification is provided to a user by turning on a light, such as a red light. In some examples, the detector notification is provided to a user by turning on a first light, such as a green light, if the detector notification includes a pass notice, and turning on a second light, such as a red light, if the detector notification includes a fail notice.

While the above description provides examples of one or more apparatuses or methods, it will be appreciated that other apparatuses or methods may be within the scope of the accompanying claims.

1. A method of detecting a material with a high atomic number, comprising:
positioning a test object that is to be examined in a muon detection apparatus;
gathering a set of test data from the muon detection apparatus, the set of test data including a set of test trajectory pairs, each test trajectory pair of the set of test trajectory pairs including an incoming trajectory of a muon as the muon travels towards the test object and an outgoing trajectory of the muon as the muon travels away from the test object;
reconstructing a set of test muon tracks from the set of trajectory pairs, each muon track of the set of test muon tracks including a scattering event and a scattering location;
identifying a set of outlier muon tracks, the set of outlier muon tracks being muon tracks of the set of test muon tracks having scattering events larger than a predetermined minimum scattering size threshold;
identifying an outlier spatial domain region having a spatial domain density of the scattering locations of the set of outlier muon tracks that is greater than a predetermined density threshold;
determining outlier region scattering density estimates for test muon tracks having the scattering location in the outlier spatial domain region;
determining, in an indicative step, if the outlier region scattering density estimates are indicative of the presence of the material with the high atomic number;
generating a detector notification, when the outlier region scattering density estimates are indicative of the presence of the material with the high atomic number; and
providing the detector notification to a user.

2. The method of claim 1, wherein the indicative step includes comparing the outlier spatial domain region to a corresponding reference region of a reference object by:
determining corresponding region scattering density estimates of the corresponding reference region; and
determining a probability that the outlier region scattering density estimates and the corresponding region scattering density estimates originated from a common population.

3. The method of claim 2, wherein the detector notification includes a fail notice if the probability is below a predetermined difference threshold and the detector notification includes a pass notice if the probability is above the predetermined difference threshold.

4. The method of claim 3, further comprising, prior to identifying the set of outlier muon tracks, combing the set of test muon tracks to remove any mis-reconstructed muon track having at least one of:
the scattering event being larger than a predetermined maximum scattering size threshold; and
the scattering location being outside the object.

5. The method of claim 2, wherein identifying an outlier spatial domain region includes:
applying a clustering algorithm to identify a spatial cluster of the scattering locations of the set of outlier muon tracks; and
defining a bounding box around the spatial cluster, the bounding box defining a set of spatial boundaries of the outlier spatial domain region.

6. The method of claim 2, wherein determining a probability that the outlier region scattering density estimates and the corresponding region scattering density estimates originated from a common population includes using a non-parametric statistical test to compare the outlier region scattering density estimates and the corresponding region scattering density estimates.

7. The method of claim 6, wherein the non-parametric statistical test includes the Anderson-Darling test.

8. The method of claim 1, wherein:
the predetermined minimum scattering size threshold includes a predetermined minimum angle threshold and a predetermined minimum distance threshold;
each scattering event includes a scattering angle and a distance of closest approach; and
identifying a set of outlier muon tracks includes identifying muon tracks having at least one of:
the scattering angle is larger than the predetermined minimum angle threshold; and
the distance of closest approach is larger than the predetermined minimum distance threshold.

9. The method of claim 1, wherein the muon detection apparatus includes at least two pairs of muon tracking detectors, and positioning a test object that is to be examined in a muon detection apparatus includes positioning the test object between the at least two pairs of muon tracking detectors.

10. The method of claim 9, wherein positioning a test object that is to be examined in a muon detection apparatus includes positioning the test object below a first pair of muon detectors of the at least two pairs of muon tracking detectors and above a second pair of muon detectors of the at least two pairs of muon tracking detectors.

11. A system for detecting a material with a high atomic number, comprising:
a muon detection apparatus operable to detect an incoming trajectory of a muon and an outgoing trajectory of the muon, to generate a test trajectory pair; and
a processing system communicatively coupled to the muon detection apparatus to receive muon trajectory data comprising a set of test trajectory pairs from the muon detection apparatus, the processing system including at least one processor operable to:
reconstruct a set of test muon tracks from the set of test trajectory pairs, each muon track of the set of test muon tracks including a scattering event and a scattering location;
identify a set of outlier muon tracks, the set of outlier muon tracks being muon tracks of the set of test muon tracks having scattering events larger than a predetermined minimum scattering size threshold;
identify an outlier spatial domain region having a spatial domain density of the scattering locations of the set of outlier muon tracks that is greater than a predetermined density threshold;
determine outlier region scattering density estimates for test muon tracks having the scattering location in the outlier spatial domain region;
determine, in an indicative step, if the outlier region scattering density estimates are indicative of the presence of the material with the high atomic number;
generate a detector notification, when the outlier region scattering density estimates are indicative of the presence of the material with the high atomic number; and
provide the detector notification to a user.

12. The system of claim 11, wherein the indicative step includes comparing the outlier spatial domain region to a corresponding reference region of a reference object by:
determining corresponding region scattering density estimates of the corresponding reference region; and
determining a probability that the outlier region scattering density estimates and the corresponding region scattering density estimates originated from a common population.

13. The system of claim 12, wherein the detector notification includes a fail notice if the probability is below a predetermined difference threshold and the detector notification includes a pass notice if the probability is above the predetermined difference threshold.

14. The system of claim 13, wherein the at least one processor is further operable to comb the set of test muon tracks to remove any mis-reconstructed muon tracks having at least one of:
the scattering event being larger than a predetermined maximum scattering size threshold; and
the scattering location being outside the object.

15. The system of claim 12, wherein, in identifying an outlier spatial domain region, the at least one processor is operable to:
apply a clustering algorithm to identify a spatial cluster of the scattering locations of the set of outlier muon tracks; and
define a bounding box around the spatial cluster, the bounding box defining a set of spatial boundaries of the outlier spatial domain region.

16. The system of claim 12, wherein in determining a probability that the outlier region scattering density estimates and the corresponding region scattering density estimates originated from a common population, the at least one processor is operable to apply a non-parametric statistical test to compare the outlier region scattering density estimates and the corresponding region scattering density estimates.

17. The system of claim 16, wherein the non-parametric statistical test includes the Anderson-Darling test.

18. The system of claim 11, wherein:
the predetermined minimum scattering size threshold includes a predetermined minimum angle threshold and a predetermined minimum distance threshold;
each scattering event includes a scattering angle and a distance of closest approach; and
in identifying a set of outlier muon tracks, the at least one processor is operable to identify muon tracks having at least one of:
the scattering angle is larger than the predetermined minimum angle threshold; and
the distance of closest approach is larger than the predetermined minimum distance threshold.

19. The system of claim 11, wherein the muon detection system includes at least two pairs of muon tracking detectors and the muon detection apparatus is operable to detect the incoming trajectory and the outgoing trajectory when the object is between the at least two pairs of muon tracking detectors.

20. The system of claim 19, wherein the muon detection apparatus includes a first pair of muon detectors and a second pair of muon detectors below the first pair of muon detectors, and the muon detection apparatus is operable to detect the incoming trajectory and the outgoing trajectory when the object is below the first pair of muon detectors and above the second pair of muon detectors.
